(19) United States
(12) Patent Application Publication
(10) Pub. No.: US 2004/0111517 A1
(43) Pub. Date: Jun. 10, 2004

(54) Servicing forwarding elements in a network

(76) Inventors: Mitu Aggarwal, Portland, OR (US); Hsin-Yuo Liu, Beaverton, OR (US); Rajeev D. Muralidhar, Hillsboro, OR (US); Puqi Tang, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/315,816

(22) Filed: Dec. 9, 2002

(51) Int. Cl. G06F 15/16

(52) U.S. Cl. 709/227

(57) ABSTRACT

A method and apparatus to provide service to an active network node may be described.

### BACKGROUND

A network node may be comprised of a number of elements. It may also have high-availability and scalability requirements and therefore a low tolerance for service interruptions. Consequently, if an element of the network node needs to be added or removed from the network node, it may be desirable to change the element without rendering the device inoperable. Accordingly, there may be a substantial need for improved techniques to service a network element while reducing interruptions to device operations.

### BRIEF DESCRIPTION OF THE DRAWINGS

The subject matter regarded as embodiments of the invention is particularly pointed out and distinctly claimed in the concluding portion of the specification. Embodiments of the invention, however, both as to organization and method of operation, together with objects, features, and advantages thereof, may best be understood by reference to the following detailed description when read with the accompanying drawings in which:

FIG. 1 is a system suitable for practicing one embodiment of the invention.

FIG. 2 is a block diagram of a network node in accordance with one embodiment of the invention.

FIG. 3 is a block diagram of a Service Management Module (SMM) in accordance with one embodiment of the invention.

FIG. 4 is a block flow diagram of operations performed by a SMM in accordance with one embodiment of the invention.

### DETAILED DESCRIPTION

Network devices such as switches and routers may be generally classified as distributed systems having three logical components, namely the control plane, the forwarding plane, and the management plane, as described in more detail below. In the interest of preserving the behavior of a network device, it may be desirable to implement “hot swapping” techniques in designing one or more elements comprising the various planes. The term “hot swapping” may refer to servicing an element of a network device without rendering the device inoperable. The term “servicing” may refer to changing the configuration of a device, such as adding an element, removing an element, replacing an element, upgrading an element and so forth.

Hot swapping techniques are an improvement over conventional servicing techniques. For example, changing an element in a network device used to require turning off power to the device, performing the service, and then turning on power to the device to resume operations. This process caused considerable disruption to service. Hot swapping techniques help to reduce these service disruptions.

Conventional hot swapping techniques, however, may be unsatisfactory for a number of reasons. For example, conventional techniques may be very specific to a particular element or device, and therefore are not very robust or adaptable. This may cause, for example, specific hardware or software redesigns to accommodate network elements from different vendors. Further, such techniques may not be suited for complex devices having multiple service elements and redundant architectures. In addition, even hot swapping techniques disrupt service operations, albeit for relatively short periods of time typically measured in seconds rather than minutes or hours. Therefore, there may be room for improvement in hot swapping techniques to reduce this disruption period even further.

The embodiments are directed to servicing an element of a network node, such as a router or switch. In one embodiment of the invention, a service event for an active network node may be initiated. The service event may be performed while the network node remains active. The term “active” as used herein may refer to a network node that is in operating mode to perform its intended function.

In one embodiment of the invention, the service event may comprise a Forwarding Element (FE) bind event to bind the FE with a Control Element (CE). This may occur, for example, whenever an FE is added to a network node. Whenever an FE is added, capabilities information for the FE may be communicated to the control plane. The control plane may use the capabilities information to bind the FE to the CE. Further, the capabilities information may be communicated using any number of communication protocols. In one embodiment of the invention, the service event may comprise an FE unbind event to unbind an FE from a CE. This may occur, for example, whenever an FE is removed from a network node.

The embodiments of the invention may provide several advantages over conventional hot swapping techniques. For example, the embodiments may be implemented as software to support hot swapping of a FE blade. Further, one embodiment may abstract the binding and capability discovery process with a standard Application Program Interface (API). Consequently, this may provide a unique way to hot-swap a FE blade without having to make modifications to proprietary software used on top of the network element. For example, a set of transport plug-in modules may be configured to accommodate a number of different FEs and communication protocols. This may make the discovery and binding process transparent to the rest of the control plane. In this manner, a network node may use elements made by different vendors, thereby making the network node more robust and potentially easier to service.

It is worthy to note that any reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Numerous specific details may be set forth herein to provide a thorough understanding of the embodiments of the invention. It will be understood by those skilled in the art, however, that the embodiments of the invention may be practiced without these specific details. In other instances, well-known methods, procedures, components and circuits have not been described in detail so as not to obscure the embodiments of the invention. It can be appreciated that the specific structural and functional details disclosed herein may be representative and do not necessarily limit the scope of the invention.

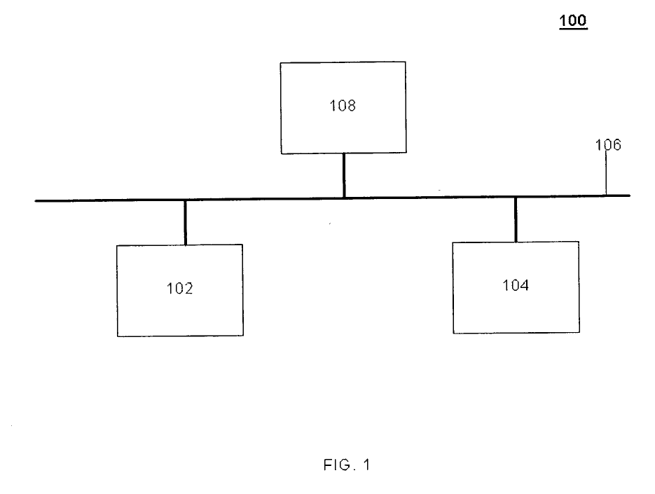

Referring now in detail to the drawings wherein like parts are designated by like reference numerals throughout, there is illustrated in FIG. 1 a system suitable for practicing one embodiment of the invention. FIG. 1 is a block diagram of a system 100 comprising a number of network nodes connected by one or more communications media. A network node in this context may include any device capable of communicating information, such as a computer, server, switch, router, bridge, gateway, personal digital assistant, mobile device and so forth. A communications medium may include any medium capable of carrying information signals, such as twisted-pair wire, co-axial cable, fiber optics, radio frequencies, electronic, acoustic or optical signals, and so forth.

More particularly, system 100 may comprise a router 102, a router 104 and a router 108, all connected by a communications medium 106. Although FIG. 1 shows only 3 network nodes, it can be appreciated that any number of network nodes may be used in system 100 and still fall within the scope of the invention. Furthermore, the terms “connection” and “interconnection,” and variations thereof, in this context may refer to physical connections and/or logical connections.

In one embodiment of the invention, system 100 may use packet forwarding to communicate information. Packet forwarding in this context may refer to communicating information over a network in the form of relatively short packets in accordance with one or more communications protocols. A packet in this context may refer to a set of information of a limited length, with the length typically represented in terms of bits or bytes. An example of a packet length might be 1000 bytes. A protocol may comprise a set of instructions by which the information signals are communicated over the communications medium. For example, the protocol might be a packet transport protocol such as the Transmission Control Protocol (TCP) as defined by the Internet Engineering Task Force (IETF) standard 7, Request For Comment (RFC) 793, adopted in September, 1981 (“TCP Specification”), built on top of the Internet Protocol (IP) as defined by the IETF standard 5, RFC 791, adopted in September, 1981 (“IP Specification”), both available from “www.ietf.org” (collectively referred to as the “TCP/IP Specification”). Packets may be addressed using any number of protocols, such as the Internet Protocol Version Four (IPv4) addressing identified by the IP Specification, and the IETF Internet Protocol Version Six (IPv6) draft standard, RFC 2460, dated December 1998 (“IPv6 Specification”), also available from “www.ietf.org.”

In one embodiment of the invention, routers 102, 104 and 108 may communicate information over communications medium 106. Information may comprise any data capable of being represented as a signal, such as an electrical signal, optical signal, acoustical signal and so forth. Examples of information in this context may include both data and control information.

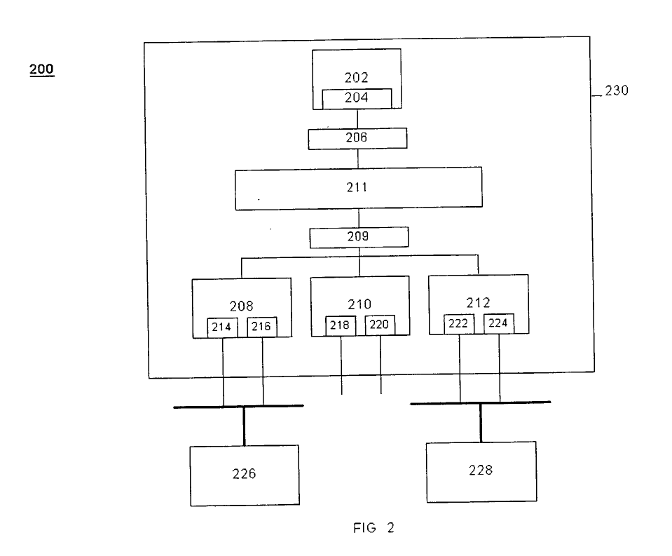

FIG. 2 illustrates a block diagram of a network node in accordance with one embodiment of the invention. FIG. 2 may illustrate a system 200 having a router 226, a router 228 and a router 230. In one embodiment, router 230 may be representative of any network node that is shown as part of systems 100 and 200, respectively.

In accordance with various embodiments of the invention, router 230 may incorporate functionality that may be implemented as software executed by a processor, hardware circuits or structures, or a combination of both. The processor may be a general-purpose or dedicated processor, such as a processor from the family of processors made by Intel Corporation, Motorola Incorporated, Sun Microsystems Incorporated and others. The software may comprise programming logic, instructions or data to implement certain functionality for an embodiment of the invention. The software may be stored in a medium accessible by a machine or computer-readable medium, such as read-only memory (ROM), random-access memory (RAM), magnetic disk (e.g., floppy disk and hard drive), optical disk (e.g., CD-ROM) or any other data storage medium. In one embodiment of the invention, the media may store programming instructions in a compressed and/or encrypted format, as well as instructions that may have to be compiled or installed by an installer before being executed by the processor. Alternatively, an embodiment of the invention may be implemented as specific hardware components that contain hard-wired logic for performing the recited functionality, or by any combination of programmed general-purpose computer components and custom hardware components.

In one embodiment of the invention, router 230 may have architecture consistent with the Control Plane Platform Development Kit (CP-PDK) Software Architecture (“CP-PDK Specification”) developed by Intel Corporation. The CP-PDK Specification describes a high-level architectural implementation of the Network Processing Forum (NPF) Application Level Application Program Interface (API) and Management Level API, as set forth in the NPF Software API Framework Implementation Agreement, Version 1, August 2002 (“NPF Specification”).

In one embodiment of the invention, router 230 may comprise a forwarding element 208, a forwarding element 210 and a forwarding element 212. Forwarding element 208 may further comprise ports 214 and 216. Forwarding element 210 may further comprise ports 218 and 220. Forwarding element 212 may further comprise ports 222 and 224. Forwarding elements 208, 210 and 212 may communicate information to a control element 202 over any communications medium, such as a back plane 211. Forwarding elements 208, 210 and 212 may also communicate information to routers 226 and 228, for example.

In one embodiment of the invention, control elements 202 may include a processor and software. Control element 202 may comprise part of a control plane for router 230. The control plane may control and configure the forwarding plane, which actually manipulates the network traffic. In general, the control plane executes different signaling or routing protocols and provides control information to the forwarding plane. For example, the control plane in router 230 may execute routing protocols like the Border Gateway Protocol (BGP) or Open Shortest Path First (OSPF).

In one embodiment of the invention, forwarding elements 208, 210 and 212 may each comprise a processor and software. Forwarding elements 208, 210 and 212 may collectively comprise part of a forwarding plane for router 230 and, in general, may perform hardware-based switching. The forwarding plane makes decisions based on control information received from the control plane, and performs operations on packets like forwarding, classification, filtering and so forth. The forwarding plane may be responsible for the “fast path” forwarding of data via the back plane and ports 214-224, for example.

In general, router 230 may also include a management plane (not shown). The management plane is typically orthogonal and manages the control and forwarding planes. It provides logging and diagnostic capabilities, non-automated configuration like operator intervention, and can activate or deactivate various control and forwarding plane modules. For example, the management plane may start or stop routing processes, or may perform logging.

In one embodiment of the invention, back plane 211 may be a meshed cross-connect switch to transport information between any of the control elements and forwarding elements. The control plane and the forwarding plane may communicate information via back plane 211 in accordance with one or more protocols. For example, in one embodiment of the invention, the control elements and forwarding elements may communicate information in accordance with the Forwarding And Control Element Separation (ForCES) protocol data model, such as defined by the IETF ForCES Working Group ForCES FE Functional Model Draft, dated June 2002 (“ForCES Protocol”), although the embodiments are not limited in this context. The particular protocol may vary dependent upon a particular implementation. For example, the protocol may report all capability information in one packet, or break up the information into smaller packets.

In one embodiment of the invention, router 230 may also comprise a Service Management Module (SMM) 204. SMM 204 may manage and coordinate servicing of one or more elements of router 230, such as forwarding elements 208, 210 and 212. The servicing may include, for example, enabling or disabling a forwarding element from the forwarding plane. Although SMM 204 may be shown as part of the control plane for router 230, it can be appreciated that SMM 204 may also be implemented in the forwarding plane or the management plane, or be distributed among two or more planes, as desired.

SMM 204 may manage servicing of the forwarding elements using a forwarding element transport module (FTM) 206 and a control element transport module (CTM) 209. FTM 206 and CTM 209 may be transport plug-in modules responsible for abstracting the connection mechanism and the communication protocol between the forwarding plane and control plane. Individual forwarding elements may be connected to the control plane across different transports, such as Ethernet, Infiniband, Peripheral Component Interconnect (PCI) and so forth, although the embodiments are not limited in this context. FTM 206 and CTM 209 may also be responsible for providing basic hot swap capabilities. For example, the basic hot swap capabilities may involve receiving asynchronous change notifications that may result in adding or removing a forwarding element, as well as the processing the appropriate events. In general, FTM 206 and CTM 209 may be configured to abstract vendor-specific details for the rest of the control plane.

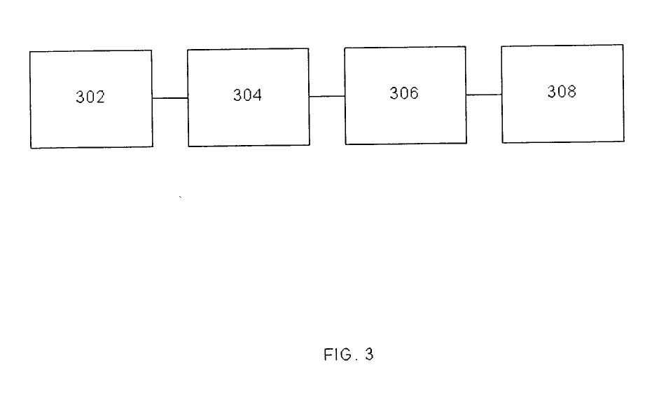

FIG. 3 may illustrate a block diagram of a SMM in accordance with one embodiment of the invention. FIG. 3 illustrates a SMM 300. SMM 300 may be representative of, for example, SMM 204. In one embodiment of the invention, SMM 300 may comprise, for example, a Binding and Discovery Module (BDM) 302, a Namespace Module (NM) 304, a Configuration Management Module (CMM) 306 and an Application Module (AM) 308. These modules may be implemented as software executed by a processor, hardware circuits or structures, or a combination of both. Further, these modules may be combined to form fewer modules, or further separated into more modules, and still fall within the scope of the invention.

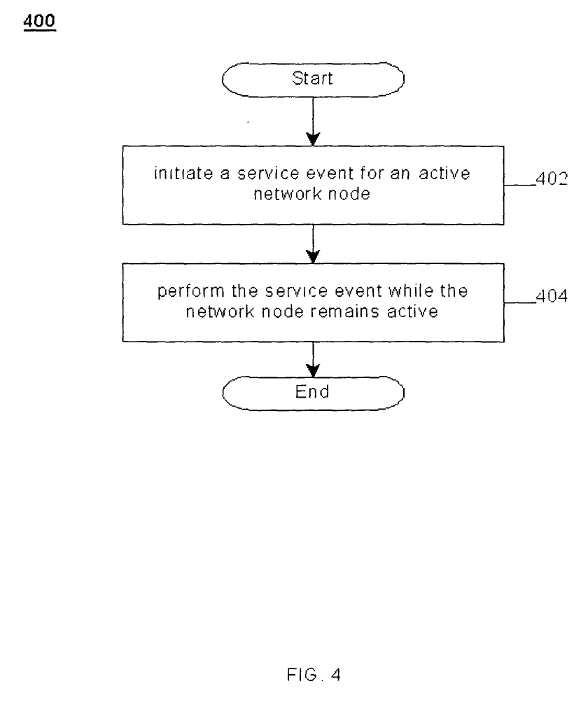

The operations of systems 100, 200 and 300 may be further described with reference to FIG. 4 and accompanying examples. Although FIG. 4 as presented herein may include a particular programming logic, it can be appreciated that the programming logic merely provides an example of how the general functionality described herein can be implemented. Further, each operation within a given programming logic does not necessarily have to be executed in the order presented unless otherwise indicated.

FIG. 4 is a block flow diagram of the operations performed by a SMM module in accordance with one embodiment of the invention. In one embodiment of the invention, this and other modules may refer to the software and/or hardware used to implement the functionality for one or more embodiments as described herein. In this embodiment of the invention, these modules may be implemented as part of a processing system, such as a processing system associated with the control plane or forwarding plane. It can be appreciated that this functionality, however, may be implemented by any element, or combination of elements, located anywhere in router 230 and still fall within the scope of the invention.

FIG. 4 illustrates a programming logic 400 for a SMM in accordance with one embodiment of the invention. In one embodiment of the invention, programming logic 400 may describe programming logic to service a network node, such as a forwarding element of router 230. As shown in programming logic 400, a service event for an active network node may be initiated at block 402. The service event may be performed while the network node remains active at block 404.

In one embodiment of the invention, the service event may comprise a FE bind event to bind the FE with a CE. Further, the FE bind event may comprise sending a bind event start message with a set of capability parameters for the FE to a CTM.

In one embodiment of the invention, the FE bind event may comprise receiving the capability parameters. A bind callback event may be initiated. A bind callback message having bind callback parameters and the capability parameters may be sent to a BDM. A bind complete message may be received. A bind callback complete message may also be received.

In one embodiment of the invention, the FE bind event may further comprise receiving the bind callback message. A FE node may be created in a namespace hierarchy. A FE node message may be sent to a NM. A namespace handle for the FE node may be received. A set FE properties message using the namespace handle may be sent to a CMM. A message may be received indicating the FE properties were set. One or more port nodes may be created in the namespace hierarchy. For each port node, a port node message may be sent to the NM. A port handle may be received. A set port properties message may be sent to the CMM using the port handle. A message indicating the port properties were set may be received. The bind complete message may then be sent to the CTM. A bind callback message may be sent to the CMM to report the FE was bound to the CE.

In one embodiment of the invention, the FE bind event may further comprise receiving the FE node message. A FE data placeholder may be created. A FE data placeholder message may be sent to the CMM. The namespace handle may be sent to the BDM. The port node message may be received. A port placeholder may be created. A port placeholder message may be sent to the CMM. The port handle may be sent to the BDM.

In one embodiment of the invention, the FE bind event may further comprise receiving an application registration message. The application may register for the FE bind event. The FE data placeholder message may be received. The set of FE properties message may also be received. The FE properties may be set. The message indicating the FE properties were set may be sent to the BDM. The port placeholder message may be received. The port properties may be set. The message indicating the port properties were set may be sent to the BDM. The bind callback message may be received. A message indicating the FE was bound to the CE may be sent to the CTM. A new FE bind message notifying the application of the FE bind event may be sent.

In one embodiment of the invention, the FE bind event may further comprise sending the application registration message. A new FE bind message may be sent.

In one embodiment of the invention, the service event may comprise a FE unbind event to unbind the FE from a CE. Further, the FE unbind event may comprise sending a lost connection message having a FE identifier to a CTM.

In one embodiment of the invention, the FE unbind event may comprise initiating an unbind callback event. An unbind callback message having unbind callback parameters and the FE identifier may be sent to a BDM. An unbind callback event complete message may be received.

In one embodiment of the invention, the FE unbind event may further comprise receiving the unbind callback message. A port down callback event may be initiated. A port down callback message may be sent to a CMM. At least one port node for the FE may be deleted. A port node delete message may be sent to a NM. A message indicating data for the port node has been deleted may be received. An FE node down event callback may be initiated. An FE node down event callback message may be sent to the CMM. A delete FE node message may be sent to the NM.

In one embodiment of the invention, the FE unbind event may further comprise receiving the port node delete message. A message to delete data for the port node may be sent to the CMM. The port node delete message may be received. A message to delete FE data may be sent to the CMM.

In one embodiment of the invention, the FE unbind event may further comprise receiving the port down callback message. The message to delete data for the port node may be received. The data for the port node may be deleted. The message indicating data for the port node has been deleted may be sent. The FE node down event callback message may be received. An FE unbind notification message may be sent to an application. The message to delete FE data may be received. The FE data may be deleted. The unbind callback event complete message may be sent. The FE unbind notification message may be received.

The operation of systems 100, 200 and 300, and the programming logic shown in FIG. 4, may be better understood by way of example. Assume that router 230 utilizes architecture in accordance with the CP PDK Specification. Further assume that router 230 is in need of a new FE. The new FE may be physically inserted into router 230. When a new FE is added, the FE may report its capabilities to FTM 209. FTM 209 transports the FE capabilities to CTM 206. Transport may be accomplished using, for example, a protocol as defined by the ForCES Specification. Since CTM 206 is responsible for abstracting the communication protocol, it may also be responsible for aggregating all the capabilities reported by the FE, before passing it up to BDM 302. It is worthy to note that since the transport protocol between FTM 209 and CTM 206 is implementation dependent, the aggregation of the capabilities may occur on either the forwarding plane or control plane.

CTM 206 may notify BDM 302 of a new FE by sending up an FE bind event. Assume a FE binds to the CE and FTM 209 reports the capabilities to the control plane. FTM 209 and CTM 206 may be configured to abstract the protocol and the mechanism used to report the capabilities. CTM 206 may then invoke a bind callback previously registered by BDM 302. The capabilities of the FE may be sent with the callback parameters. BDM 302 may then create a node in the Namespace Hierarchy. This may ensure that a placeholder is created for storing and maintaining FE data. A namespace handle corresponding to the new FE node may be returned to BDM 302. BDM 302 may use the handle to initialize any FE data information received during the FE bind event.

BDM 302 may invoke NM 304 to create port nodes in the Namespace Hierarchy under the FE node to which the port belongs. BDM 302 may receive the handle to the port object. Using the port handle, the placeholder created for the port data in CMM 306 may be updated with the port capabilities passed up during the bind process. BDM 302 may force the FE to pass up all the port capabilities in one shot, if desirable. This may complete the bind process. BDM 302 may invoke the callback registered by CMM 306 to indicate that a new FE has bound to the CE. CMM 306 may send the notification for the new FE Bind up to AM 308.

Similarly, when an FE is removed, CTM may send an FE unbind event to BDM 302. Assume a FE loses the connection from CE for any reason. CTM 206 invokes the FE unbind callback registered by BDM 302. The FE identifier may be sent with the callback parameters. BDM 302 may then invoke the port down callback registered by CMM 306 for all the ports belonging to this particular FE. BDM 302 may delete all the port nodes in the Namespace Hierarchy under the FE node that was unbound. NM 304 may delete the actual port data stored in CMM 306. BDM 302 may then invoke the FE down callback registered by CMM 306 for this FE. CMM 306 may send up the FE Unbind notification to AM 308. BDM 302 may invoke NM 304 to delete the FE node in the Namespace Hierarchy. NM 304 may invoke CMM 306 to delete the actual FE data stored in the CP PDK system. This may complete the FE Unbind Event.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

1. A method to service a network element, comprising:
initiating a service event for an element of an active network node;
performing said service event by processing a set of capabilities associated with said element.

2. The method of claim 1, wherein said service event comprises a Forwarding Element (FE) bind event to bind said FE with a Control Element (CE).

3. The method of claim 2, wherein said FE bind event comprises sending a bind event start message with a set of capability parameters for said FE to a CE Transport Module (CTM).

4. The method of claim 3, further comprising:
receiving said capability parameters;
initiating a bind callback event;
sending a bind callback message having bind callback parameters and said capability parameters to a Binding and Discovery Module (BDM);
receiving a bind complete message; and
receiving a bind callback complete message.

5. The method of claim 4, further comprising:
receiving said bind callback message;
creating a FE node in a namespace hierarchy;
sending a FE node message to a Namespace Module (NM);
receiving a namespace handle for said FE node;
sending a set FE properties message using said namespace handle to a Configuration and Management Module (CMM);
receiving a message indicating said FE properties were set;
creating at least one port node in said namespace hierarchy;
sending a port node message to said NM;
receiving a port handle;
sending a set port properties message using said port handle to said CMM;
receiving a message indicating said port properties were set;
sending said bind complete message to said CTM; and
sending a bind callback message to CMM to report said FE was bound to said CE.

6. The method of claim 5, further comprising:
receiving said FE node message;
creating a FE data placeholder;
sending a FE data placeholder message to said CMM;
sending said namespace handle to said BDM;
receiving said port node message;
creating a port placeholder;
sending a port placeholder message to said CMM; and
sending said port handle to said BDM.

7. The method of claim 6, further comprising:
receiving an application registration message;
registering said application for said FE bind event;
receiving said FE data placeholder message;
receiving said set FE properties message;
setting said FE properties;
sending said message indicating said FE properties were set to said BDM;
receiving said port placeholder message;
setting said port properties;
sending said message indicating said port properties were set to said BDM;
receiving said bind callback message;
sending a message indicating said FE was bound to said CE to said CTM; and
sending a new FE bind message notifying said application of said FE bind event.

8. The method of claim 7, further comprising:
sending said application registration message; and
receiving said new FE bind message.

9. The method of claim 1, wherein said service event comprises a Forwarding Element (FE) unbind event to unbind said FE from a Control Element (CE).

10. The method of claim 9, wherein said FE unbind event comprises sending a lost connection message having a FE identifier to a CE Transport Module (CTM).

11. The method of claim 10, further comprising:
initiating an unbind callback event;
sending an unbind callback message having unbind callback parameters and said FE identifier to a Binding and Discovery Module (BDM); and
receiving an unbind callback event complete message.

12. The method of claim 11, further comprising:
receiving said unbind callback message;
initiating a port down callback event;
sending a port down callback message to a Configuration Management Module (CMM);
deleting at least one port node for said FE;
sending a port node delete message to a Namespace Module (NM);
receiving a message indicating data for said port node has been deleted;
initiating an FE node down event callback;
sending an FE node down event callback message to said CMM; and
sending a delete FE node message to said NM.

13. The method of claim 12, further comprising:
receiving said port node delete message;
sending a message to delete data for said port node to said CMM;
receiving said port node delete message; and
sending a message to delete FE data to said CMM.

14. The method of claim 13, further comprising:
receiving said port down callback message;
receiving said message to delete data for said port node;
deleting said data for said port node;
sending said message indicating data for said port node has been deleted;
receiving said FE node down event callback message;
sending an FE unbind notification message to an application;
receiving said message to delete FE data;
deleting said FE data; and
sending said unbind callback event complete message.

15. The method of claim 14, further comprising receiving said FE unbind, notification message.

16. An apparatus, comprising:
a forwarding plane comprising at least one forwarding element (FE);
a control plane comprising at least one control element (CE);
a back plane for communicating capabilities information between said forwarding plane and said control plane;
a FE transport module (FTM) to aggregate and communicate said capabilities information using said back plane;
a CE transport module (CTM) to receive said capabilities information; and
a service management module (SMM) to initiate a FE bind event to discover and bind said FE to said CE using said capabilities information.

17. The apparatus of claim 16, wherein said SMM comprises:
a binding and discovery module (BDM) to manage discovery and binding of said FE to said CE;
a namespace module (NM) to create a FE node and at least one port node to store FE information during said FE bind event;
a configuration management module (CMM) to store FE and port capabilities information; and
an application module (AM) to use said bound FE.

18. The apparatus of claim 16, wherein said information may be communicated in accordance with a Forwarding And Control Element Separation (ForCES) Specification.

19. An article comprising:
a storage medium;
said storage medium including stored instructions that, when executed by a processor, result in servicing a network element by initiating a service event for an element of an active network node, and performing said service event by processing a set of capabilities associated with said element.

20. The article of claim 19, wherein the stored instructions, when executed by a processor, further result in performing said service event by initiating a Forwarding Element (FE) bind event to bind said FE with a Control Element (CE).

21. The article of claim 20, wherein the stored instructions, when executed by a processor, further result in said FE bind event by sending a bind event start message with a set of capability parameters for said FE to a CE Transport Module (CTM).

22. The article of claim 21, wherein the stored instructions, when executed by a processor, further result in receiving said capability parameters, initiating a bind callback event, sending a bind callback message having bind callback parameters and said capability parameters to a Binding and Discovery Module (BDM), receiving a bind complete message, and receiving a bind callback complete message.

23. The article of claim 22, wherein the stored instructions, when executed by a processor, further result in receiving said bind callback message, creating a FE node in a namespace hierarchy, sending a FE node message to a Namespace Module (NM), receiving a namespace handle for said FE node, sending a set FE properties message using said namespace handle to a Configuration and Management Module (CMM), receiving a message indicating said FE properties were set, creating at least one port node in said namespace hierarchy, sending a port node message to said NM, receiving a port handle, sending a set port properties message using said port handle to said CMM, receiving a message indicating said port properties were set, sending said bind complete message to said CTM, and sending a bind callback message to CMM to report said FE was bound to said CE.

24. The article of claim 23, wherein the stored instructions, when executed by a processor, further result in receiving said FE node message, creating a FE data placeholder, sending a FE data placeholder message to said CMM, sending said namespace handle to said BDM, receiving said port node message, creating a port placeholder, sending a port placeholder message to said CMM, and sending said port handle to said BDM.

25. The article of claim 24, wherein the stored instructions, when executed by a processor, further result in receiving an application registration message, registering said application for said FE bind event, receiving said FE data placeholder message, receiving said set FE properties message, setting said FE properties, sending said message indicating said FE properties were set to said BDM, receiving said port placeholder message, setting said port properties, sending said message indicating said port properties were set to said BDM, receiving said bind callback message, sending a message indicating said FE was bound to said CE to said CTM, and sending a new FE bind message notifying said application of said FE bind event.

26. The article of claim 25, wherein the stored instructions, when executed by a processor, further result in sending said application registration message, and receiving said new FE bind message.

27. The article of claim 19, wherein the stored instructions, when executed by a processor, further result in performing said service event by initiating a Forwarding Element (FE) unbind event to unbind said FE from a Control Element (CE).

28. The article of claim 27, wherein the stored instructions, when executed by a processor, further result in sending a lost connection message having a FE identifier to a CE Transport Module (CTM).

29. The article of claim 28, wherein the stored instructions, when executed by a processor, further result in initiating an unbind callback event, sending an unbind callback message having unbind callback parameters and said FE identifier to a Binding and Discovery Module (BDM), and receiving an unbind callback event complete message.

30. The article of claim 29, wherein the stored instructions, when executed by a processor, further result in receiving said unbind callback message, initiating a port down callback event, sending a port down callback message to a Configuration Management Module (CMM), deleting at least one port node for said FE, sending a port node delete message to a Namespace Module (NM), receiving a message indicating data for said port node has been deleted, initiating an FE node down event callback, sending an FE node down event callback message to said CMM, and sending a delete FE node message to said NM.

31. The article of claim 30, wherein the stored instructions, when executed by a processor, further result in receiving said port node delete message, sending a message to delete data for said port node to said CMM, receiving said port node delete message; and sending a message to delete FE data to said CMM.

32. The article of claim 31, wherein the stored instructions, when executed by a processor, further result in receiving said port down callback message, receiving said message to delete data for said port node, deleting said data for said port node, sending said message indicating data for said port node has been deleted, receiving said FE node down event callback message, sending an FE unbind notification message to an application, receiving said message to delete FE data, deleting said FE data, and sending said unbind callback event complete message.

33. The article of claim 32, wherein the stored instructions, when executed by a processor, further result in receiving said FE unbind notification message.
